(19) United States
(12) Patent Application Publication
(10) Pub. No.: US 2019/0138022 A1
(43) Pub. Date: May 9, 2019

(54) FLOOR-DROP DETECTION SYSTEM FOR MOBILE ROBOT

(71) Applicants: Fu Tai Hua Industry (Shenzhen) Co., Ltd., Shenzhen (CN); Hon Hai Precision Industry Co., Ltd., New Taipei (TW)

(72) Inventors: Yu-Chun Sun, New Taipei (TW); Ze-Min Wu, Shenzhen (CN); Zhan-Sheng Lu, Shenzhen (CN)

(21) Appl. No.: 15/835,409

(22) Filed: Dec. 7, 2017

(30) Foreign Application Priority Data
Nov. 6, 2017 (CN) 201721466716.6

(51) Int. Cl. G05D 1/02

(52) U.S. Cl. CPC G05D 1/0242; Y10S 901/01

(57) ABSTRACT

A system whereby a mobile robot can detect a floor-drop includes a chassis and at least one infrared (IR) sensor. The chassis includes a mounting portion and a translucent lens mounted on the mounting portion. The mounting portion and the translucent lens are inclined downwards, at an angle to a horizontal plane. The IR sensor is mounted in the chassis adjacent to the translucent lens. The IR sensor transmits a signal to a lower surface in front of the chassis through the transparent lens. The IR sensor can detect a distant floor-drop such that the mobile robot can have enough time to stop a front wheel going over the floor-drop.

### CROSS REFERENCE TO RELATED APPLICATION

This application claims priority to Chinese Patent Application No. 201721466716.6, filed on Nov. 6, 2017, the disclosure of which is incorporated herein by reference in its entirety.

### FIELD

The present disclosure relates generally to mobile robots controls, and more particularly to a drop-off detection system for a mobile robot.

### BACKGROUND

A mobile robot such as a cleaning robot has the capability to move to perform tasks. In order to prevent the mobile robot from running off a stair, the mobile robot employs an infrared (IR) sensor at a lower front edge thereof. The IR sensor transmits a signal which is reflected by a floor surface below the mobile robot, and receives the reflected signal from the floor surface. The IR sensor detects sudden drops in the floor surface when the strength of the received reflected signal is greatly varied. However, the distance between the signal irradiation position by the IR sensor on the floor surface and a front wheel of the mobile robot is short. Thus, even if the IR sensor detects a drop-off, the mobile robot can still run off because the front wheel of the mobile robot is too close to the drop.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a perspective view of a floor-drop detection system for a mobile robot.

FIG. 2 is a side view of the detection system of FIG. 1.

FIG. 3 is a cross-sectional view taken along line in FIG. 1.

FIG. 4 is a bottom view of the detection system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

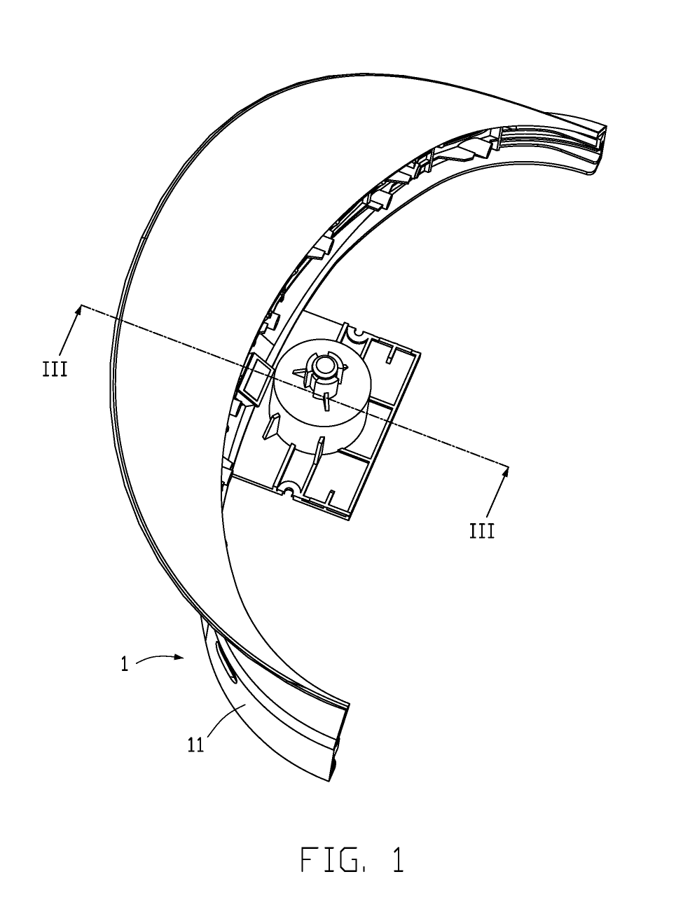

With reference to FIGS. 1-3, an exemplary embodiment of a floor-drop detection system for a mobile robot includes a chassis 1, at least one IR sensor 2, and at least one light-blocking foam 3.

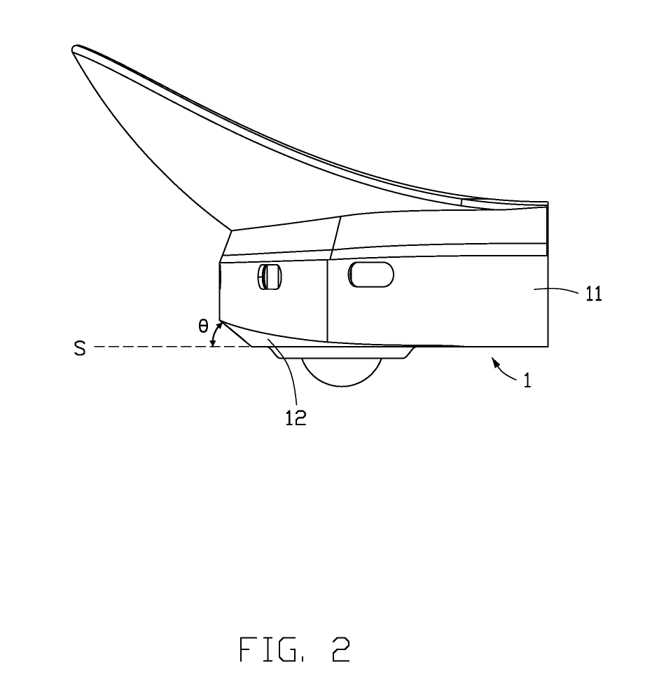

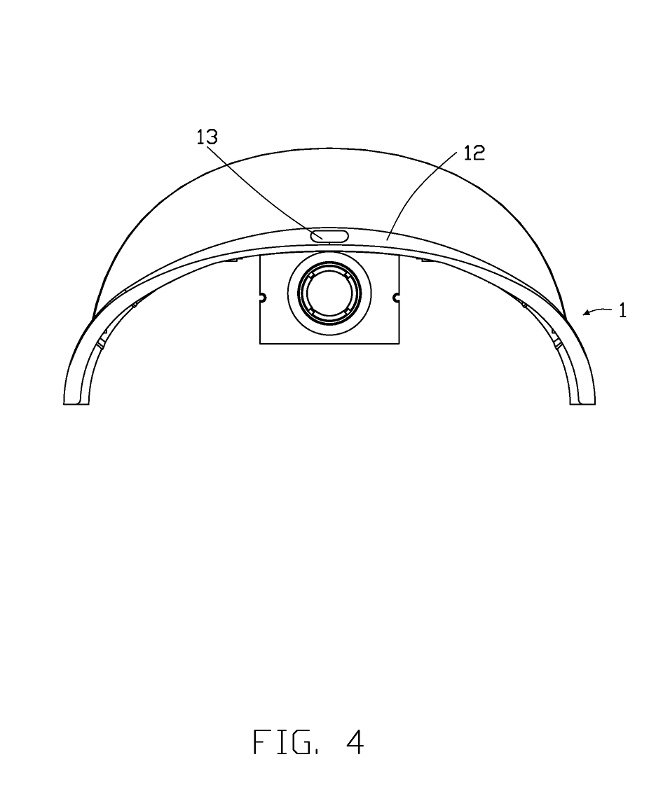

With reference to FIGS. 2 and 4, the chassis 1 includes a curved protection portion 11, a curved mounting portion 12, and a translucent lens 13. The protection portion 11 is perpendicular to a horizontal plane S. The mounting portion 12 is connected to a lower edge of the protection portion 11. The translucent lens 13 is mounted on a center of the mounting portion 12. The translucent lens 13 is made of polymethylmethacrylate (PMMA). The mounting portion 12 and the translucent lens 13 are inclined downwards, at an angle θ to the horizontal plane S. The angle θ of the mounting portion 12 and the transparent lens 13 is approximately 40 degrees with respect to the horizontal plane S.

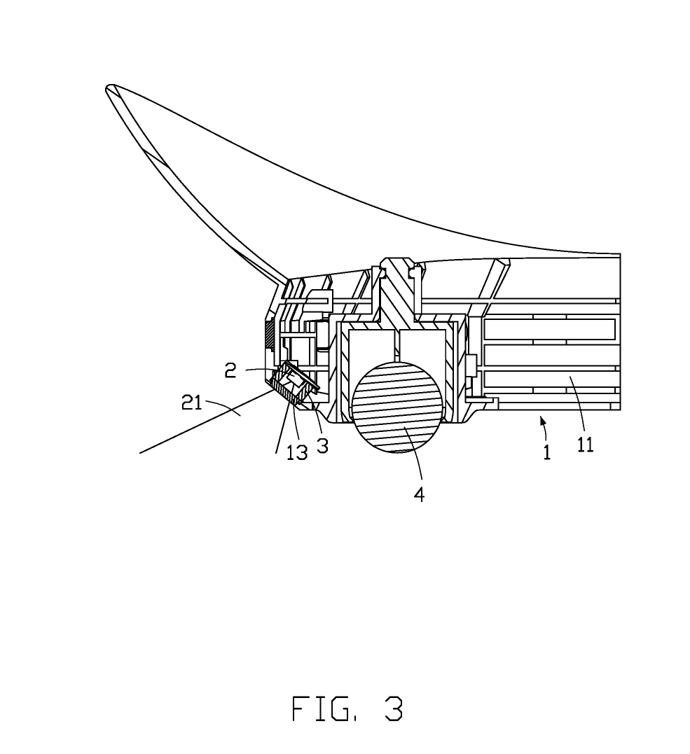

With reference to FIG. 3, the IR sensor 2 is mounted in the chassis 1 adjacent to the translucent lens 13. The IR sensor 2 is configured to transmit, receive, and analyze IR signals. The IR sensor 2 transmits a signal 21 to a floor surface in front of the chassis 1 through the transparent lens 13, and receives the reflected signal 21 from the floor surface. The IR sensor 2 detects floor-drops in the floor surface when determining that the strength of the received reflected signal 21 suddenly changes. The IR sensor 2 is conventional and thus a detailed description thereof will be omitted.

The number of the at least one light-blocking foam 3 is the same as the number of the at least one IR sensor 2. Each light-blocking foam 3 is mounted around an IR sensor 2.

Preferably, two spaced-apart IR sensors 2 are mounted in the chassis 1, and a light-blocking foam 3 is mounted around each one.

The IR sensor 2 is located at the inclined mounting portion 12 such that the signal 21 transmitted by the IR sensor 2 is directed down in front of the chassis 1. The distance between a signal irradiation position by the IR sensor 2 on the lower surface and a front wheel 4 of the mobile robot is long. Thus, the IR sensor 2 can detect a floor-drop in advance, and the mobile robot can have enough time to stop itself.

The exemplary embodiments shown and described above are only examples. Many details are often found in the art such as the other features of a floor-drop detection system for a mobile robot. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A floor-drop detection system for a mobile robot comprising:
a chassis comprising a mounting portion and a translucent lens mounted on the mounting portion; and
at least one infrared (IR) sensor mounted in the chassis adjacent to the translucent lens;
wherein the mounting portion and the translucent lens are inclined downwards, at an angle to a horizontal plane, and the IR sensor transmits a signal to a lower surface in front of the chassis through the transparent lens.

2. The floor-drop detection system of claim 1, wherein the angle of the mounting portion and the transparent lens with respect to the horizontal plane is 40 degrees.

3. The floor-drop detection system of claim 1, wherein the chassis comprises a protection portion perpendicular to the horizontal plane, and the mounting portion is connected to a lower edge of the protection portion.

4. The floor-drop detection system of claim 2, wherein the chassis comprises a protection portion perpendicular to the horizontal plane, and the mounting portion is connected to a lower edge of the protection portion.

5. The floor-drop detection system of claim 3, wherein the protection portion is curved and the mounting portion is curved.

6. The floor-drop detection system of claim 4, wherein the protection portion is curved and the mounting portion is curved.

7. The floor-drop detection system of claim 1, wherein the translucent lens is mounted on a center of the mounting portion.

8. The floor-drop detection system of claim 2, wherein the translucent lens is mounted on a center of the mounting portion.

9. The floor-drop detection system of claim 3, wherein the translucent lens is mounted on a center of the mounting portion.

10. The floor-drop detection system of claim 4, wherein the translucent lens is mounted on a center of the mounting portion.

11. The floor-drop detection system of claim 5, wherein the translucent lens is mounted on a center of the mounting portion.

12. The floor-drop detection system of claim 6, wherein the translucent lens is mounted on a center of the mounting portion.

13. The floor-drop detection system of claim 1, further comprising at least one light-blocking foam;
wherein a number of the at least one light-blocking foam is the same as a number of the at least one IR sensor, and each of the at least one light-blocking foam is mounted around a corresponding one of the at least one IR sensor.

14. The floor-drop detection system of claim 2, further comprising at least one light-blocking foam;
wherein a number of the at least one light-blocking foam is the same as a number of the at least one IR sensor, and each of the at least one light-blocking foam is mounted around a corresponding one of the at least one IR sensor.

15. The floor-drop detection system of claim 3, further comprising at least one light-blocking foam;
wherein a number of the at least one light-blocking foam is the same as a number of the at least one IR sensor, and each of the at least one light-blocking foam is mounted around a corresponding one of the at least one IR sensor.

16. The floor-drop detection system of claim 4, further comprising at least one light-blocking foam;
wherein a number of the at least one light-blocking foam is the same as a number of the at least one IR sensor, and each of the at least one light-blocking foam is mounted around a corresponding one of the at least one IR sensor.

17. The floor-drop detection system of claim 5, further comprising at least one light-blocking foam;
wherein a number of the at least one light-blocking foam is the same as a number of the at least one IR sensor, and each of the at least one light-blocking foam is mounted around a corresponding one of the at least one IR sensor.

18. The floor-drop detection system of claim 6, further comprising at least one light-blocking foam;
wherein a number of the at least one light-blocking foam is the same as a number of the at least one IR sensor, and each of the at least one light-blocking foam is mounted around a corresponding one of the at least one IR sensor.

19. The floor-drop detection system of claim 7, further comprising at least one light-blocking foam;
wherein a number of the at least one light-blocking foam is the same as a number of the at least one IR sensor, and each of the at least one light-blocking foam is mounted around a corresponding one of the at least one IR sensor.

20. The floor-drop detection system of claim 8, further comprising at least one light-blocking foam;
wherein a number of the at least one light-blocking foam is the same as a number of the at least one IR sensor, and each of the at least one light-blocking foam is mounted around a corresponding one of the at least one IR sensor.
